(19) United States
(12) Patent Application Publication
(10) Pub. No.: US 2002/0124211 A1
(43) Pub. Date: Sep. 5, 2002

(54) PCI error determination using error signatures or vectors

(75) Inventors: Forrest Clifton Gray, Austin, TX (US); Michael Anthony Perez, Cedar Park, TX (US); Mark Walz Wenning, Cedar Park, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/798,287

(22) Filed: Mar. 1, 2001

(51) Int. Cl. G06F 13/00

(52) U.S. Cl. 714/39

(57) ABSTRACT

A method of automatically determining errors and appropriate solutions to those errors in a PCI-based computer system is disclosed. The method is easy to maintain and efficient, because it eliminates the need for inefficient and difficult-to-understand program code containing large numbers of cascaded conditional statements.

### BACKGROUND OF THE INVENTION

1. Technical Field

The present invention is directed generally toward a method of identifying an error in a data processing system. Specifically, the invention is directed toward a method of error and solution determination for use in computer systems utilizing Peripheral Component Interconnect (PCI) technology.

2. Description of Related Art:

A typical computer system includes a central processing unit (CPU) for performing computations, memory, and peripheral devices such as display monitors, printers, and disk drives for offline storage and communication with the outside world. Without something to interconnect these components, however, they cannot function as a system.

The primary apparatus for the interconnection of components in a computer system is known as a bus. A bus is a group of signals that allows for communication between devices. A bus is like a data expressway, where the computer system components are positioned at the entrance and exit ramps. For instance, the central processing unit, memory, and peripheral devices may all be connected in parallel to a single bus.

Several different levels of buses may exist in a computer system. At the lowest level is the component-oriented (local) bus, which connects directly to the CPU. Component-oriented buses are generally specific to the particular type of CPU being used. For instance, the component-oriented bus in a computer system built around a Pentium microprocessor (CPU) is incompatible with a PowerPC microprocessor (CPU).

In many computers, however, there are two or more levels of buses (particularly in more modern computer systems). The component-oriented bus is often supplemented with a backplane or system bus. A backplane bus does not interface directly with the CPU, but is connected to the component-oriented bus by means of a backplane-to-host bridge.

Using a backplane bridge has a number of advantages, but two of them are of particular importance. First, because backplane buses are not connected to the component-oriented bus and CPU directly, when a component on the backplane bus fails, there is less likelihood of complete system failure, because the failure is isolated. Second, because backplane buses need not be specific to a particular model of processor, it is possible to have backplane bus standards that are independent of the choice of processor. This allows peripheral devices such as input/output (I/O) adapters to be interchangeable among disparate computing platforms.

One such backplane bus standard, which has gained wide acceptance across a variety of computing platforms, is the Peripheral Component Interconnect standard (PCI for short). PCI provides a high-speed platform-independent interface for peripheral devices. In addition, multiple PCI buses may be connected together in a hierarchical fashion through PCI-to-PCI bridges, such that each peripheral device is the sole peripheral on a given PCI bus. This allows peripheral devices that fail to be isolated from other peripheral devices.

When one or more components of a PCI-based system fail, users or technical personnel need to be made aware of the problem so that the problem may be corrected. A problem with a failed device can usually be corrected by replacing the failed device with another piece of hardware, a “field-replaceable unit.” It is usually desirable to identify the least amount of replacement hardware necessary to fix the problem. This identification is often a non-trivial task.

To simplify the identification of a problem and its solution, computer software has been developed. Such software operates by reading status registers associated with the components in the system. Typically, this type of software identifies the problem by testing the status register values with a number of conditional statements (“if” statements).

Error determination code written with many conditional statements suffers from a number of drawbacks. First, such code tends to be slow because many conditional statements must be executed before an error is determined. In particular, conditional statements, particularly on modern pipelined processors, tend to take much more time to execute than other statements. Second, modification of program code with many conditional statements is difficult. Finally, such program code is difficult to read, difficult to write, and difficult to maintain.

Therefore, it would be advantageous to have an improved method and apparatus for identifying system errors and solutions.

### SUMMARY OF THE INVENTION

The present invention provides a method operable in a PCI-based computer system to automatically determine system errors and appropriate solutions, in which the method does not require the execution of many conditional statements.

In the present invention, status register values are combined to create a new value, called a vector. The vector is used as a search key to retrieve one or more possible problem solutions. The retrieved solutions are then sorted such that more desirable solutions, such as those requiring the least amount of hardware, are listed first.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a computer system utilizing Peripheral Component Interconnect (PCI) bus technology.

FIG. 2 is an example C++ language implementation of prior art error detection method.

FIG. 3 is a diagram illustrating the operation of a preferred embodiment of the present invention from the perspective of system memory.

FIG. 4 is an example C++ language implementation of a preferred embodiment of the present invention.

FIG. 5 is a flowchart depicting the sequential operation of a preferred embodiment of the present invention.

### DETAILED DESCRIPTION OF THE DRAWINGS

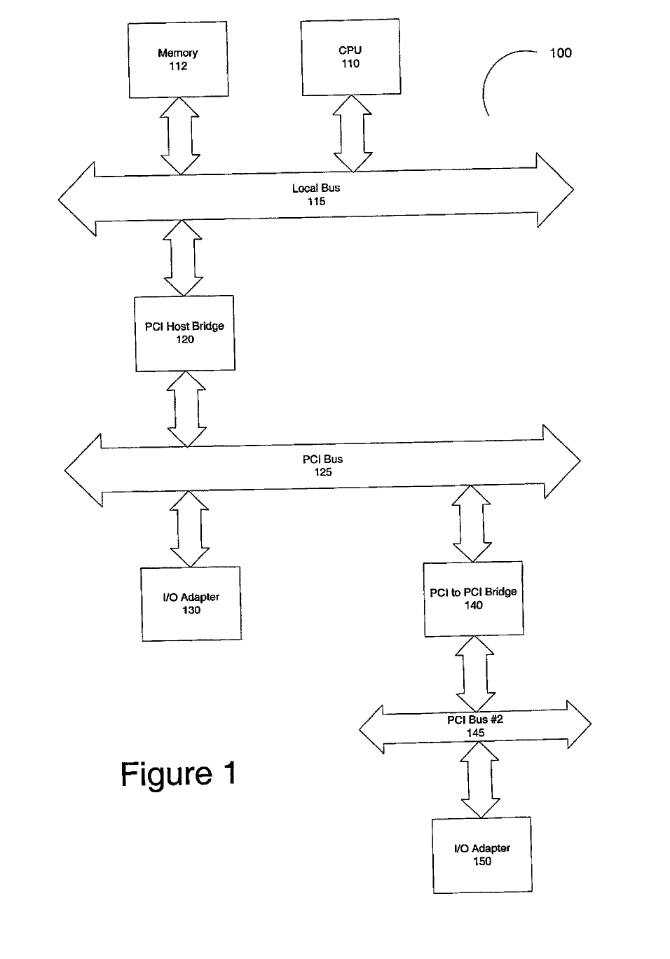

FIG. 1 contains a block diagram of a typical computer system utilizing Peripheral Component Interconnect (PCI) bus technology 100. PCI is an industry standard expansion bus interface and is often used in personal computer systems.

A central processing unit (CPU) 110 is connected to a local bus 115 for communication with memory 112 and with other components internal to the computer system. Typically the local bus 115 conforms to a standard that is specific to the manufacturer and model of CPU 110. External peripherals such as input/output (I/O) adapter 130 are connected to a PCI expansion bus 125. A primary advantage of using a PCI expansion bus to connect external peripherals is that the external peripherals need not be designed to work specifically with CPU 110, but may be platform-independent. Communication between the CPU 110 and external peripherals such as the I/O adapter 130 is facilitated by a PCI host-bus bridge 120, which transfers data between the local bus 115 and the PCI expansion bus 125.

It is also possible to have an additional PCI expansion bus, such as PCI expansion bus 145, which communicates with PCI expansion bus 125. Communication between the two buses 125 and PCI expansion bus 145 is facilitated by a PCI-to-PCI bus bridge 140, which transfers data between the two buses 125, 145. This arrangement is useful when there are several I/O adapters are located within a system. If each I/O adapter is on a separate PCI bus, then when one adapter starts producing bus errors, the other adapters are not affected.

As can be seen from FIG. 1, in a typical computer system utilizing PCI bus technology, a hierarchy of devices, buses, and bridges is present. If one or more of these components fail, components further down the hierarchy from CPU 110 will also be rendered useless. For instance, if PCI-to-PCI bridge 140 fails, I/O adapter 150 on PCI bus 145 has no way of communicating with CPU 110, and thus is rendered useless.

Each of the components has associated with it a status register that stores a status code, corresponding to the status of the component. When a component fails, its status register changes value to reflect the failure.

When one or more components fail, the problem can usually be rectified by making use of a field replaceable unit (FRU), which will generally provide the minimum portion of hardware to fix the problem. In a complex system, however, determining where the problem is and what steps should be taken to fix the problem is not always easy. To simplify this process, software systems have been developed that can diagnose a problem and present a solution.

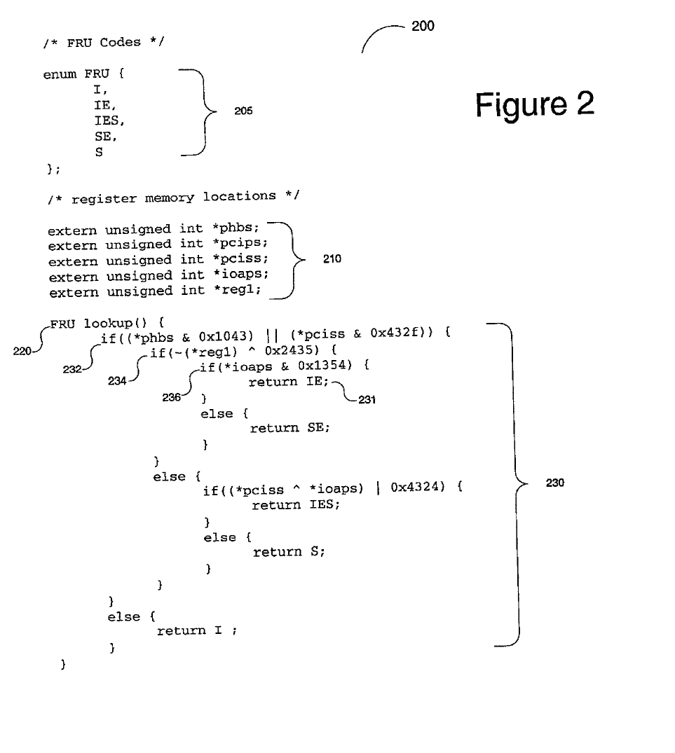

FIG. 2 provides a C source code listing 200 of a typical diagnostic routine 220 in such a software system. FIG. 2 illustrates diagnostic routine 220 is typically written. A set of pointers 210 provide access to status registers corresponding to various components in the system. Diagnostic routine 220 is implemented as a function that returns an enumerated “FRU” type 205. The enumerated “FRU” type corresponds to the FRU to be used in the particular failure scenario.

The logic of diagnostic routine 220 is contained in a series of nested “if/else” conditional statements 230. Diagnostic routine 220 returns a particular FRU if and only if a specified set of conditions is fulfilled. For instance, the function 220 returns the FRU “IE” in line 231, but only if all of the conditions in lines 232, 234, and 236 are satisfied with respect to the register values pointed to by the set of pointers 210.

As can be seen from FIG. 2, this technique of implementing an FRU lookup routine suffers from a number of drawbacks. Firstly, it is inefficient. For instance, before executing line 231 in FIG. 2, the conditions in lines 232, 234, and 236 must first be tested. The more tests that must be executed, the more code must be executed, and the more slowly the routine 220 runs.

Secondly, it is difficult to make changes using this technique. If the conditions for selecting a given FRU change, the whole program must be recompiled.

Finally, code containing many conditional statements is difficult to read, difficult to write, and difficult to maintain. Clearly, an easier-to-maintain solution is desirable. The present invention provides such a solution.

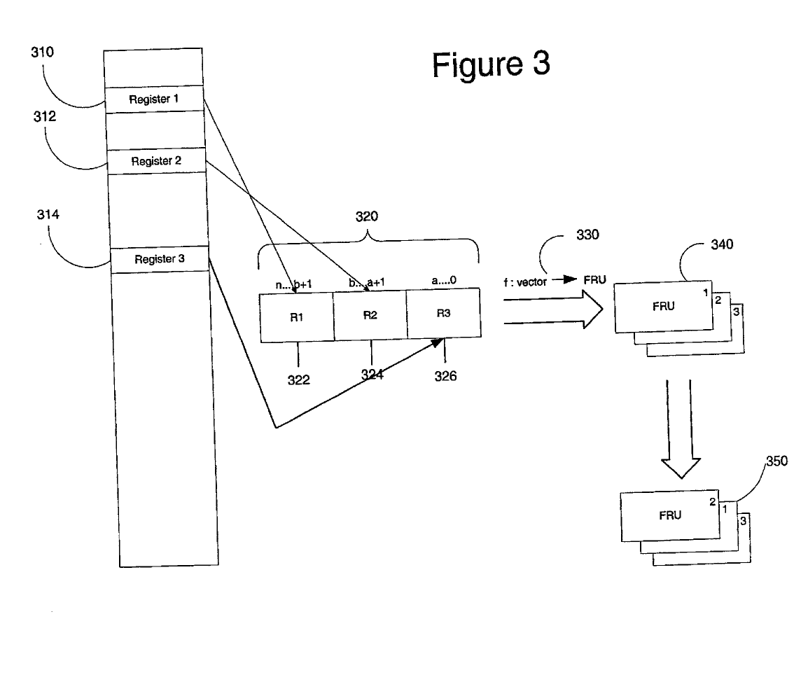

FIG. 3 demonstrates the operation of a preferred embodiment of the present invention, which dispenses with the copious conditional statements of the prior art. Status registers 310, 312, 314, corresponding to components of the computer system, are located within the addressable memory space 300 of the computer system.

Each of registers 310, 312, 314 contains a binary number. These binary numbers are all expressible as strings of zeroes and ones. If a series of these strings is concatenated together, the result is simply a larger binary number. In this example, the binary numbers stored in registers 310, 312, 314 are concatenated into a larger binary number, which also can be called a bit vector 320. The contents of registers 310, 312, 314 become bit fields 322, 324, 326 in bit vector 320. For instance, in FIG. 3, the contents of register 314 become bits 0 through a in bit field 326 in bit vector 320, the contents of register 312 become bits a+1 through b in bit field 324, and the contents of register 1 310 become bits b+1 through n in bit field 322.

Bit vector 320 can then be used to look up one or more FRUs 340 through the use some sort of data structure 330 providing a mapping relation between bit vectors and FRUs. Data structure 330 can be any sort of data structure that can map a given key into a corresponding set of values. Eligible data structures include (but are not limited to) arrays, search trees, hash tables, and linked lists, all of which are well known in the computer programming field.

Finally, FRUs 340 are sorted 350 such that more desirable FRUs (for instance, those that involve less hardware or setup) are reported to technical personnel first.

One skilled in the art will appreciate that the present invention is preferable over the prior art because (among other things) it is easier to maintain (only the contents of a data structure need be modified; no software modifications are necessary) and more efficient (data structures, when optimized for speed, are more efficient than cascaded conditional statements).

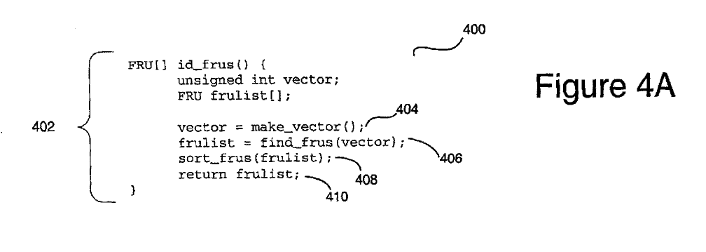

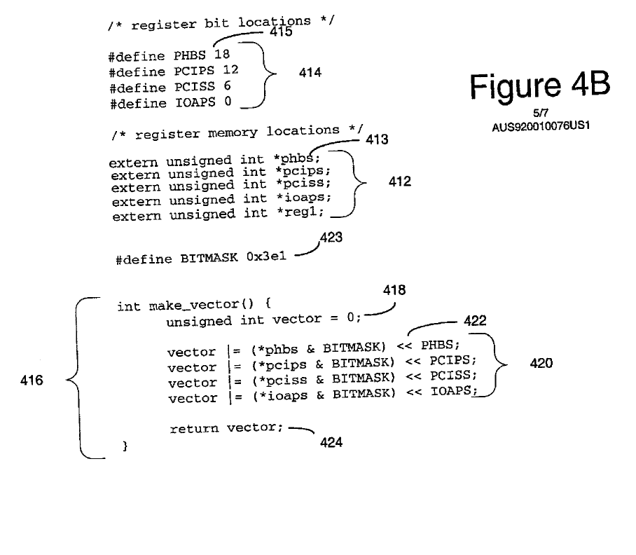

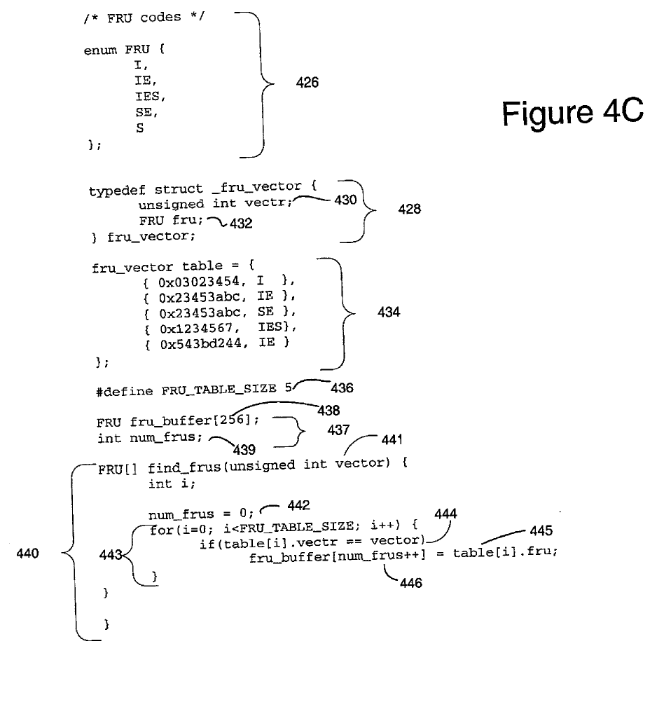

FIG. 4A is a diagram of a C listing 400 that provides an overview of a preferred embodiment of the present invention. Those of ordinary skill in the art will appreciate that such a software implementation is not limited to the use of the C language but may be implemented in any of a variety of computer languages, including but not limited to C++, Java, Forth, Lisp, Scheme, Python, Perl, and Assembly Languages of all kinds. It is also to be emphasized that this C listing 400 is merely an example of one possible implementation of the present invention, included to clarify the basic concepts underlying the invention by providing them in a concrete form. FIG. 4A should not be interpreted as limiting the invention to a particular software implementation.

FIG. 4A provides a listing of a C function 402, “id_frus,” which returns an array of type “FRU.” “FRU” is an enumerated type denoting different possible field-replaceable units (FRUs).

In line 404 of function 402, a bit vector is assembled from the status register values of components within the system. In line 406, the vector is used as a search key to find and assemble a list of possible FRUs applicable to the current component status. In line 408, the list is sorted so that more desirable FRUs are listed first. A number of sorting techniques for enumerable data exist in the prior art that may be applicable to this step, including (but not limited to) quick sort, heap sort, and radix sort. Finally, in line 410, the sorted list is returned from the function to be reported to technical personnel.

FIG. 4B provides a C listing 411 demonstrating how a bit vector can be assembled from register values. In the C listing 411, the component registers are addressable through pointers 412, which in this case are pointers to 32-bit integers.

A set of bit locations 414 is also defined. Each of pointers 412 is associated with one of bit locations 414. For instance, the phbs (PCI-host bridge status) register, the pointer for which is defined in line 413, has a bit location of 26, as defined in line 415. This association means that when the bit vector (320 in FIG. 3) is assembled, the contents of the phbs register will have its least significant bit located at bit 26 of bit vector 320 in FIG. 3.

The bit vector is assembled by “make_vector” function 416. First a variable “vector” is defined in line 418 and given a value of zero. Next, a series of instructions 420 assembles the vector from the component status registers. Line 422, the first of these, takes the value stored in the phbs register and logical-ands the value with a bitmask 423. By logical-anding the value with the bitmask, bits from the original register value that do not contain any useful information are set to zero, with only the useful bits retained. Next, the bits of the resulting value are shifted left a number of times that is equal to the bit location PHBS. Then this left-shifted amount is logical-ored with the variable vector.

This process is repeated for the remaining registers 420, and the result is a single binary number containing all of the needed status information from the registers, which is returned 424 from function 416.

FIG. 4C provides a C language demonstration of how, once a vector has been created, the proper FRUs can be found in a preferred embodiment of the invention. The first part of the C code in FIG. 4C defines data structures for implementing a table 434 mapping bit vectors to FRUs.

A enumerated type “FRU” 426 is first defined to denote different possible FRUs that may be used to correct a problem. Next, a struct “fru_vector” 428 is defined. The struct “fru_vector” defines a pairing of an integer bit vector (“vectr”) 430 with a FRU 432. Table 434 is an array of “fru_vectors.” The size of the array is defined as a macro, “FRU_TABLE_SIZE,” in line 436. In this example, the size is five.

As can be readily observed, making modifications to the table is straightforward. Modification only involves adding, removing, or changing table entries. None of the program logic need be modified. This makes maintenance of software produced in accordance with the present invention simple.

Next, a storage area 437 is defined for storing the results of the FRU search. This storage area contains an array “fru_buffer” 438 for storing the FRU values themselves and a count variable 439 for storing the number of FRUs contained in array 438.

The actual task of locating the proper FRUs is performed by function “find_frus” 440. Function “find_frus” 440 takes an integer bit vector as an argument. Execution of function “find_frus” 440 is as follows: In line 442, count variable 439 is set to zero, as no FRUs have been found yet. A counted loop 443 iterates over all of the “fru_vectors” in table 434. Integer vector portion 430 of each “fru_vector” is checked in line 444 against the bit vector passed in to function 441. If they match, FRU portion 432 of the “fru_vector” is stored 445 in the next available space in “fru_buffer” as shown in line 438, and count variable 439 is incremented in line 446.

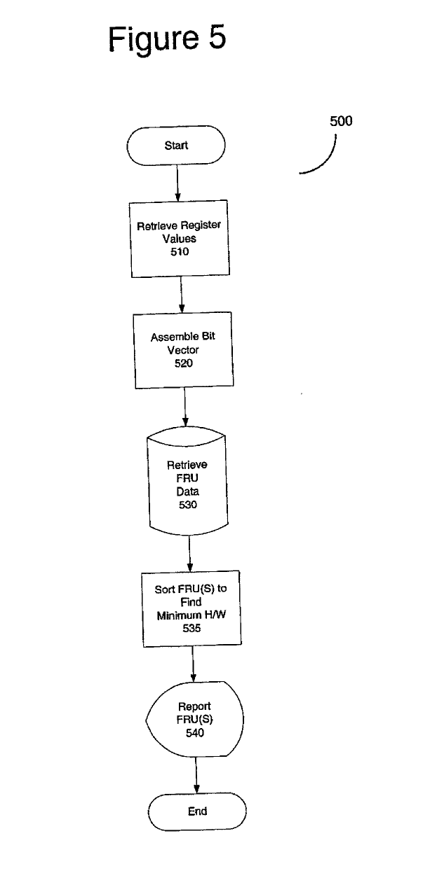

FIG. 5 provides a flowchart representation 500 of the sequence of operations followed in a preferred embodiment of the present invention. First, component status register values are retrieved (step 510). Second, those register values are combined to produce a bit vector (step 520). Third, the bit vector is used as a key to retrieve the proper FRUs corresponding to the component statuses embedded in the bit vector (step 530). Fourth, the FRUs found in step 530 are sorted so that more desirable FRUs (generally those that require the least amount of hardware) will be reported first (step 535). Finally, the proper choices of FRUs are reported (step 540).

It is important to note that while the present invention has been described in the context of a fully functional data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for determining of corrective measures in a data processing system, the method comprising the steps of:
(a) reading status values from a plurality of status registers;
(b) combining the status values to form a new value; and
(c) using the new value to search a set of corrective measures for at least one corrective measure.

2. The method of claim 1, wherein the set of corrective measures are stored in a database.

3. The method of claim 2, wherein the new value is a search key used to query the database.

4. The method of claim 1, wherein the plurality of status registers are associated with a plurality of components.

5. The method of claim 4, wherein the plurality of components includes at least one Peripheral Component Interconnect (PCI) device.

6. The method of claim 4, wherein the plurality of components includes at least one software component.

7. The method of claim 4, wherein the plurality of components includes at least one hardware component.

8. The method of claim 1, wherein the status values are strings of binary digits (bits).

9. The method of claim 8, wherein step (b) includes a step (d) of performing bitwise operations on the strings of binary digits to form the new value.

10. The method of claim 9, wherein step (d) includes a step of concatenating the strings of binary digits.

11. The method of claim 9, wherein step (d) includes a step of modifying the strings of binary digits using a bitmask.

12. The method of claim 1, wherein the at least one corrective measure includes a replacement of at least one component with a specified field replaceable unit (FRU).

13. The method of claim 1, comprising the step of:
(d) sorting the at least one corrective measure so that the at least one corrective measure is in decreasing order of desirability.

14. The method of claim 13, wherein the at least one corrective measure includes a replacement of at least one component with a specified field replacement unit (FRU).

15. The method of claim 14, wherein corrective measures that require replacement of a greater number of components are less desirable than corrective measures that require replacement of a smaller number of components.

16. The method of claim 1, comprising the step of:
(d) reporting the at least one corrective measure to a user.

17. A computer program product, in a computer-readable medium, for determining in a data processing system, the computer program product comprising instructions for:
(a) reading status values from a plurality of status registers;
(b) combining the status values to form a new value; and
(c) using the new value to search a set of corrective measures for at least one corrective measure.

18. The computer program product of claim 17, wherein the set of corrective measures are stored in a database.

19. The computer program product of claim 18, wherein the new value is a search key used to query the database.

20. The computer program product of claim 17, wherein the plurality of status registers are associated with a plurality of components.

21. The computer program product of claim 20, wherein the plurality of components includes at least one Peripheral Component Interconnect (PCI) device.

22. The computer program product of claim 20, wherein the plurality of components includes at least one software component.

23. The computer program product of claim 20, wherein the plurality of components includes at least one hardware component.

24. The computer program product of claim 17, wherein the status values are strings of binary digits (bits).

25. The computer program product of claim 24, wherein the instructions for (b) include instructions for:
(d) performing bitwise operations on the strings of binary digits to form the new value.

26. The computer program product of claim 25, wherein the instructions for (d) include instructions for concatenating the strings of binary digits.

27. The computer program product of claim 25, wherein the instructions for (d) include instructions for modifying the strings of binary digits using a bitmask.

28. The computer program product of claim 17, wherein the at least one corrective measure includes a replacement of at least one component with a specified field replaceable unit (FRU).

29. The computer program product of claim 17, comprising instructions for:
(d) sorting the at least one corrective measure so that the at least one corrective measure is in decreasing order of desirability.

30. The computer program product of claim 29, wherein the at least one corrective measure includes a replacement of at least one component with a specified field replacement unit (FRU).

31. The computer program product of claim 30, wherein corrective measures that require replacement of a greater number of components are less desirable than corrective measures that require replacement of a smaller number of components.

32. The computer program product of claim 17, comprising instructions for:
(d) reporting the at least one corrective measure to a user.

33. A system for error determination in a computer system having a central processing unit (CPU), comprising:
a plurality of components in communication with the central processing unit, wherein each of the plurality of components is associated with a status register from a plurality of status registers,
wherein the central processing unit combines values from the plurality of status registers to form a vector and wherein the central processing unit searches a database to find at least one corrective measure associated with the vector.

34. The system of claim 33, wherein the plurality of components includes a bus.

35. The system of claim 34, wherein the bus is a Peripheral Component Interconnect (PCI) bus.

36. The system of claim 33, wherein the plurality of components includes a PCI-host bridge.

37. The system of claim 33, wherein the plurality of components includes a PCI-to-PCI bridge.

38. The system of claim 33, wherein the plurality of components includes an input/output (I/O) adapter.

39. The system of claim 33, wherein the central processing unit sorts the at least one corrective measure in order of decreasing desirability.

40. The system of claim 33, wherein the at least one corrective measure includes replacement of a subset of the plurality of components with a field-replaceable unit.
